(19) United States
(12) Patent Application Publication
(10) Pub. No.: US 2014/0208771 A1
(43) Pub. Date: Jul. 31, 2014

(54) GAS TURBINE ENGINE COMPONENT COOLING ARRANGEMENT

(71) Applicant: United Technologies Corporation, (US)

(72) Inventors: James M. Koonankeil, Marlborough, CT (US); Edward F. Pietraszkiewicz, Southington, CT (US); Dominic J. Mongillo, Jr., West Hartford, CT (US)

(73) Assignee: UNITED TECHNOLOGIES CORPORATION, Hartford, CT (US)

(21) Appl. No.: 13/729,387

(22) Filed: Dec. 28, 2012

(51) Int. Cl. F02C 7/12

(52) U.S. Cl. CPC F02C 7/12
USPC 60/806; 60/722

(57) ABSTRACT

A component for a gas turbine engine according to an exemplary aspect of the present disclosure includes, among other things, a body portion having an exterior surface and an internal surface. A cavity is disposed inside of the body portion. A cooling hole extends between the exterior surface and the internal surface and includes a metering section having an outlet and an inlet. The inlet is shaped dissimilar to the outlet.

### BACKGROUND

This disclosure relates to a gas turbine engine, and more particularly to a component that may be incorporated into a gas turbine engine. The component can include one or more cooling holes as part of a cooling arrangement for cooling the component.

Gas turbine engines typically include a compressor section, a combustor section and a turbine section. During operation, air is pressurized in the compressor section and is mixed with fuel and burned in the combustor section to generate hot combustion gases. The hot combustion gases are communicated through the turbine section, which extracts energy from the hot combustion gases to power the compressor section and other gas turbine engine loads.

Both the compressor and turbine section may include alternating series of rotating blades and stationary vanes that extend into the core flow path of the gas turbine engine. For example, in the turbine section, turbine blades rotate and extract energy from the hot combustion gases that are communicated along the core flow path of the gas turbine engine. The turbine vanes, which generally do not rotate, guide the airflow and prepare it for the next set of blades.

The gas turbine engine may include a number of components that extend into the core flow path of the gas turbine engine. For example, airfoils of blades and vanes may extend into the core flow path of the gas turbine engine. The airfoils may include cooling holes that are part of a cooling arrangement of the component. Cooling airflow is communicated into an internal cavity of the component and can be discharged through the cooling holes to provide a boundary layer of film cooling air at the external surface of the component. The film cooling air provides a barrier that protects the underlying substrate of the component from the hot combustion gases that are communicated along the core flow path.

### SUMMARY

A component for a gas turbine engine according to an exemplary aspect of the present disclosure includes, among other things, a body portion having an exterior surface and an internal surface. A cavity is disposed inside of the body portion. A cooling hole extends between the exterior surface and the internal surface and includes a metering section having an outlet and an inlet. The inlet is shaped dissimilar to the outlet.

In a further non-limiting embodiment of the foregoing gas turbine engine, the body portion is an airfoil.

In a further non-limiting embodiment of either of the foregoing gas turbine engines, the component is a vane.

In a further non-limiting embodiment of any of the foregoing gas turbine engines, the component is a blade.

In a further non-limiting embodiment of any of the foregoing gas turbine engines, the inlet includes an angled shape.

In a further non-limiting embodiment of any of the foregoing gas turbine engines, the inlet includes a conical shape.

In a further non-limiting embodiment of any of the foregoing gas turbine engines, the inlet includes a bellmouth shape.

In a further non-limiting embodiment of any of the foregoing gas turbine engines, the metering section is cylindrical.

In a further non-limiting embodiment of any of the foregoing gas turbine engines, the outlet includes a round shape.

In a further non-limiting embodiment of any of the foregoing gas turbine engines, the cooling hole is internally formed in a direction that extends from the internal surface toward the exterior surface.

In a further non-limiting embodiment of any of the foregoing gas turbine engines, the gas turbine engine comprises a second cooling hole. The inlet of the cooling hole includes a first shape and an inlet of the second cooling hole includes a second shape that is different from the first shape.

In a further non-limiting embodiment of any of the foregoing gas turbine engines, the inlet is oriented to at least partially extend in the same direction as a direction of flow of a cooling airflow that is circulated inside the cavity.

In a further non-limiting embodiment of any of the foregoing gas turbine engines, the inlet includes an upstream portion that is converging.

In a further non-limiting embodiment of any of the foregoing gas turbine engines, the outlet is formed at the exterior surface and the inlet is formed at the internal surface.

In a further non-limiting embodiment of any of the foregoing gas turbine engines, the outlet includes a diffused shape.

A gas turbine engine according to an exemplary aspect of the present disclosure includes, among other things, a compressor section and a combustor section in fluid communication with the compressor section. A turbine section is in fluid communication with the combustor section. A component is disposed in at least one of the compressor section and the turbine section. The component includes a body portion having an exterior surface and an internal surface, a cavity disposed inside the body portion and a cooling hole that extends between the exterior surface and the internal surface and includes a metering section having an outlet and an inlet. The inlet is shaped dissimilar to the outlet.

In a further non-limiting embodiment of the foregoing gas turbine engine, the inlet includes an angled shape.

In a further non-limiting embodiment of either of the foregoing gas turbine engines, the inlet includes a conical shape.

In a further non-limiting embodiment of any of the foregoing gas turbine engines, the inlet includes a bellmouth shape.

In a further non-limiting embodiment of any of the foregoing gas turbine engines, the gas turbine engine comprises a second cooling hole. The inlet of the cooling hole includes a first shape and an inlet of the second cooling hole includes a second shape that is different from the first shape.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 illustrates a schematic, cross-sectional view of a gas turbine engine.

FIG. 2 illustrates a component that can be incorporated into a gas turbine engine.

FIG. 3 illustrates another component that can be incorporated into a gas turbine engine.

FIG. 4 illustrates an exemplary cooling arrangement that can be incorporated into a component of a gas turbine engine.

### DETAILED DESCRIPTION

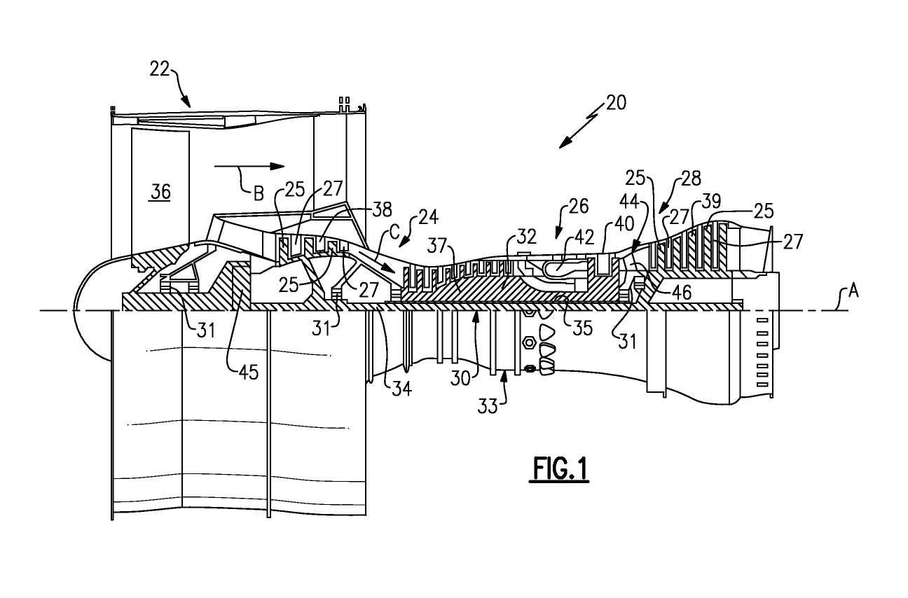

FIG. 1 schematically illustrates a gas turbine engine 20. The exemplary gas turbine engine 20 is a two-spool turbofan engine that generally incorporates a fan section 22, a compressor section 24, a combustor section 26 and a turbine section 28. Alternative engines might include an augmenter section (not shown) among other systems or features. The fan section 22 drives air along a bypass flow path B, while the compressor section 24 drives air along a core flow path C for compression and communication into the combustor section 26. The hot combustion gases generated in the combustor section 26 are expanded through the turbine section 28. Although depicted as a turbofan gas turbine engine in the disclosed non-limiting embodiment, it should be understood that the concepts described herein are not limited to turbofan engines and these teachings could extend to other types of engines, including but not limited to, three-spool engine architectures.

The gas turbine engine 20 generally includes a low speed spool 30 and a high speed spool 32 mounted for rotation about an engine centerline longitudinal axis A. The low speed spool 30 and the high speed spool 32 may be mounted relative to an engine static structure 33 via several bearing systems 31. It should be understood that other bearing systems 31 may alternatively or additionally be provided.

The low speed spool 30 generally includes an inner shaft 34 that interconnects a fan 36, a low pressure compressor 38 and a low pressure turbine 39. The inner shaft 34 can be connected to the fan 36 through a geared architecture 45 to drive the fan 36 at a lower speed than the low speed spool 30. The high speed spool 32 includes an outer shaft 35 that interconnects a high pressure compressor 37 and a high pressure turbine 40. In this embodiment, the inner shaft 34 and the outer shaft 35 are supported at various axial locations by bearing systems 31 positioned within the engine static structure 33.

A combustor 42 is arranged between the high pressure compressor 37 and the high pressure turbine 40. A mid-turbine frame 44 may be arranged generally between the high pressure turbine 40 and the low pressure turbine 39. The mid-turbine frame 44 can support one or more bearing systems 31 of the turbine section 28. The mid-turbine frame 44 may include one or more airfoils 46 that extend within the core flow path C.

The inner shaft 34 and the outer shaft 35 are concentric and rotate via the bearing systems 31 about the engine centerline longitudinal axis A, which is co-linear with their longitudinal axes. The core airflow is compressed by the low pressure compressor 38 and the high pressure compressor 37, is mixed with fuel and burned in the combustor 42, and is then expanded over the high pressure turbine 40 and the low pressure turbine 39. The high pressure turbine 40 and the low pressure turbine 39 rotationally drive the respective high speed spool 32 and the low speed spool 30 in response to the expansion.

In a non-limiting embodiment, the gas turbine engine 20 is a high-bypass geared aircraft engine. In a further example, the gas turbine engine 20 bypass ratio is greater than about six (6:1). The geared architecture 45 can include an epicyclic gear train, such as a planetary gear system or other gear system. The example epicyclic gear train has a gear reduction ratio of greater than about 2.3, and in another example is greater than about 2.5:1. The geared turbofan enables operation of the low speed spool 30 at higher speeds, which can increase the operational efficiency of the low pressure compressor 38 and low pressure turbine 39 and render increased pressure in a fewer number of stages.

The pressure ratio of the low pressure turbine 39 can be pressure measured prior to the inlet of the low pressure turbine 39 as related to the pressure at the outlet of the low pressure turbine 39 and prior to an exhaust nozzle of the gas turbine engine 20. In one non-limiting embodiment, the bypass ratio of the gas turbine engine 20 is greater than about ten (10:1), the fan diameter is significantly larger than that of the low pressure compressor 38, and the low pressure turbine 39 has a pressure ratio that is greater than about five (5:1). It should be understood, however, that the above parameters are only exemplary of one embodiment of a geared architecture engine and that the present disclosure is applicable to other gas turbine engines, including direct drive turbofans.

In this embodiment of the exemplary gas turbine engine 20, a significant amount of thrust is provided by the bypass flow path B due to the high bypass ratio. The fan section 22 of the gas turbine engine 20 is designed for a particular flight condition—typically cruise at about 0.8 Mach and about 35,000 feet. This flight condition, with the gas turbine engine 20 at its best fuel consumption, is also known as bucket cruise Thrust Specific Fuel Consumption (TSFC). TSFC is an industry standard parameter of fuel consumption per unit of thrust.

Fan Pressure Ratio is the pressure ratio across a blade of the fan section 22 without the use of a Fan Exit Guide Vane system. The low Fan Pressure Ratio according to one non-limiting embodiment of the example gas turbine engine 20 is less than 1.45. Low Corrected Fan Tip Speed is the actual fan tip speed divided by an industry standard temperature correction of [(Tram °R)/(518.7°R)]^{0.5}, where T represents the ambient temperature in degrees Rankine. The Low Corrected Fan Tip Speed according to one non-limiting embodiment of the example gas turbine engine 20 is less than about 1150 fps (351 m/s).

Each of the compressor section 24 and the turbine section 28 may include alternating rows of rotor assemblies and vane assemblies (shown schematically) that carry airfoils that extend into the core flow path C. For example, the rotor assemblies can carry a plurality of rotating blades 25, while each vane assembly can carry a plurality of vanes 27 that extend into the core flow path C. The blades 25 of the rotor assemblies create or extract energy (in the form of pressure) from the core airflow that is communicated through the gas turbine engine 20 along the core flow path C. The vanes 27 of the vane assemblies direct the core air flow to the blades 25 to either add or extract energy.

Various components of the gas turbine engine 20, such as the blades 25 and the vanes 27 on the compressor section 24 and/or the turbine section 28, may be subjected to repetitive thermal cycling under widely ranging temperatures and pressures. The hardware of the turbine section 28 is particularly subjected to relatively extreme operating conditions. Therefore, some components may require cooling arrangements for cooling the components that extend into the core flow path C. Exemplary cooling arrangements that include cooling holes are described herein.

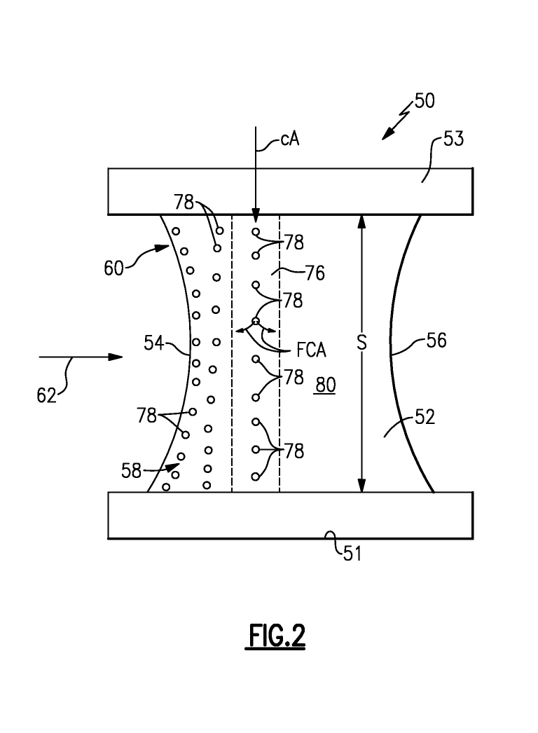

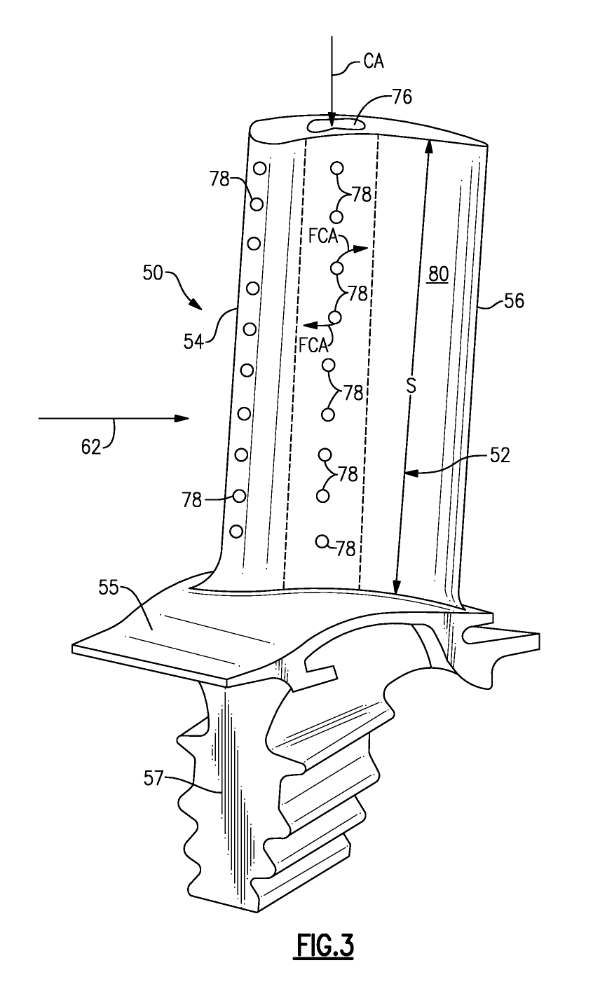

FIG. 2 illustrates a component 50 that can be incorporated into a gas turbine engine, such as the gas turbine engine 20 of FIG. 1. The component 50 includes a body portion 52 that axially extends between a leading edge 54 and a trailing edge 56 and circumferentially extends between a pressure side 58 and a suction side 60. In this embodiment, the body portion 52 is representative of an airfoil. For example, the body portion 52 could be an airfoil that extends between an inner diameter platform 51 and an outer diameter platform 53 where the component is a vane. Alternatively, as shown in FIG. 3, the body portion 52 could extend from a platform portion 55 and a root portion 57 where the component 50 is a blade. In yet another embodiment, the body portion 52 could be a non-airfoil portion of a component, such as a seal body of a blade outer air seal (BOAS).

A gas path 62 is communicated axially downstream through the gas turbine engine 20 along the core flow path C in a direction that extends from the leading edge 54 toward the trailing edge 56 of the body portion 52. The gas path 62 is representative of the communication of core airflow along the core flow path C. The body portion 52 extends radially across a span S between the inner diameter platform 51 and the outer diameter platform 53, in this embodiment.

The component 50 may include a cooling arrangement having a cavity 76 that extends inside of the body portion 52 and one or more cooling holes 78 that extend through an exterior surface 80 of the body portion 52. The cavity 76 can receive a cooling airflow CA to cool the internal surfaces of the body portion 52. In one exemplary embodiment, the cooling airflow CA is a bleed airflow that can be sourced from the compressor section 24 or any other portion of the gas turbine engine 20 that is positioned upstream from the component 50. The cavity 76 defines a hollow opening through the body portion 52. The cooling airflow CA can be communicated through the cavity 76, which extends across the span S of the body portion 52, to cool the internal surfaces of the body portion 52.

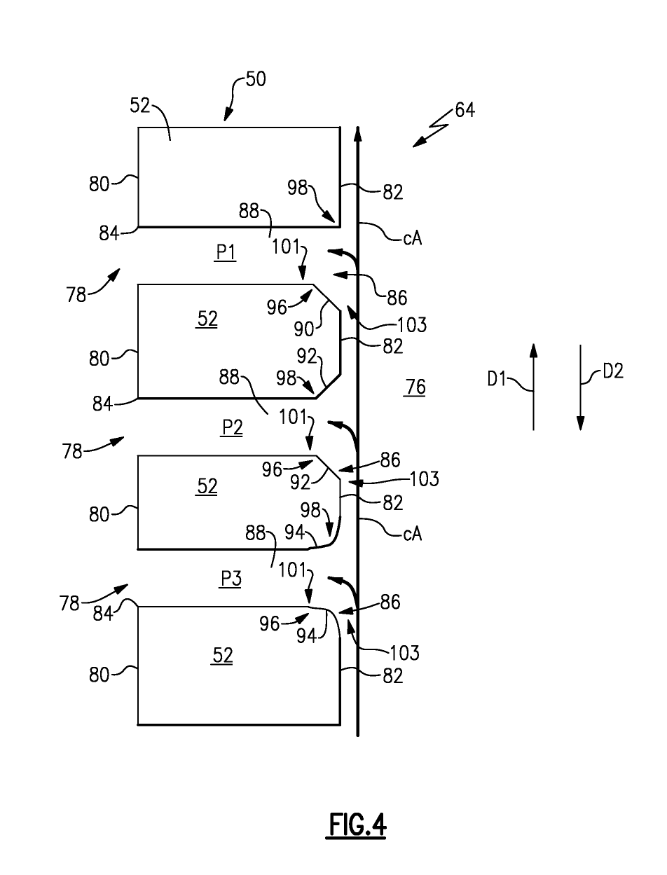

In this embodiment, the component 50 includes a plurality of cooling holes 78 that extend through the body portion 52 between the exterior surface 80 and an internal surface 82 (best shown in FIG. 4) that is in fluid communication with the cavity 76. The cooling holes 78 break through each of the exterior surface 80 and the internal surface 82 of the body portion 52 into the cavity 76. The cooling holes 78 can be positioned at any location of the component 50 including the leading edge 54, the trailing edge 56, the pressure side 58, the suction side 60, airfoil tip portions and platform portions. The cooling holes 78 may be spaced apart along the span S of the body portion 52 and can be arranged in multiple, collinear rows for discharging the cooling airflow CA and providing a boundary layer of film cooling air FCA along the exterior surface 80 of the body portion 52.

The cooling arrangement described herein can be disposed in any component that requires dedicated cooling, including but not limited to any component that is positioned within the core flow path C (FIG. 1) of the gas turbine engine 20. In the illustrated embodiments, and only for the purposes of providing detailed examples herein, the exemplary cooling holes of this disclosure are illustrated with respect to airfoils, such as those of vanes (FIG. 2) and/or blades (FIG. 3) of the compressor section 24 and/or the turbine section 28. It should be understood, however, that the teachings of this disclosure are not limited to these particular applications and could extend to other components of the gas turbine engine 20 that may be exposed to relatively extreme environments, including but not limited to, blade outer air seals (BOAS), mid-turbine frames, combustor panels, etc.

FIG. 4 (with continued reference to FIGS. 2 and 3) illustrates one exemplary cooling arrangement 64 that can be incorporated into a component 50. The cooling arrangement 64 is generally disposed inside of a body portion 52 of the component 50. In this particular embodiment, the cooling arrangement 64 includes a cavity 76 that extends through the component 50 and a plurality of cooling holes 78. The cooling arrangement 64 could include one or more cooling holes 78. The actual number of cooling holes 78 that make up the cooling arrangement 64 may vary depending upon the cooling requirements of the component 50.

Each cooling hole 78 of the cooling arrangement 64 is in fluid communication with the cavity 76. The cooling holes 78 include a metering section 88 that includes an outlet 84 and an inlet 86 that can terminate at the opposing ends of the metering section 88. The cooling holes 78 may also include diffusing portions (not shown) in which case the inlet 86 and the outlet 84 could terminate at an exterior surface 80 and interior surface 82 of the body portion 52. The metering section 88 of each cooling hole 78 extends between the inlet 86 and the outlet 84. In one embodiment, the metering section 88 is cylindrical such that the cooling hole 78 is not tapered between the outlet 84 and the inlet 86. In other words, the metering section 88 is non-tapered between the outlet 84 and the inlet 86. In another embodiment, the metering section 88 includes a shape other than cylindrical.

In one embodiment, the inlet 86 is shaped dissimilarly to the outlet 84. In other words, the inlet 86 may include a first shape that is different from a second shape of the outlet 84. The outlet 84 and the inlet 86 may embody any of a variety of shapes.

The inlet 86 can include an upstream portion 101 and a downstream portion 103. In this embodiment, the upstream portion 101 is convergent and the downstream portion 103 is straight and can include a cross-sectional shape that is round, oval, slotted, square, rectangular or may be diffused with various shapes that may or may not be similar to the internal shape resulting in divergent flow.

For example, as shown at position P1 of the body portion 52, the inlet 86 can include an angled shape 90. In this embodiment, a radially inner portion 96 of the inlet 86 of the cooling hole 78 at position P1 is angled in a direction away from a radially outer portion 98 of the inlet 86. Other angled configurations are also contemplated.

The inlet 86 can also include a conical shape 92 (as shown at position P2 of the body portion 52). Both the radially inner portion 96 and the radially outer portion 98 of the inlet 86 are angled to establish the conical shape 92, in this particular embodiment.

In yet another embodiment, as shown at position P3 of the body portion 52, the inlet 86 of the cooling hole 78 can include a bellmouth shape 94. The bellmouth shape 94 may be defined at both the radially inner portion 96 and the radially outer portion 98 of the inlet 86.

This disclosure is not limited to inlets 86 having angled 90, conical 92 or bellmouth shapes 94. These shapes are only shown and described as potential embodiments that provide improved flow control and stability of the cooling airflow CA that is communicated within the cooling arrangement 64. It should also be understood that the cooling arrangement 64 may include any combination of inlet 86 shapes. For example, one component may include cooling holes 78 having inlets 86 with conical shapes 92, while another component could include cooling holes 78 having a mixture of angled 90, conical 92 and bellmouth shapes 94.

In this embodiment, the outlets 84 of the cooling holes 78 positioned at each position P1, P2 and P3 include a round shape (see FIGS. 2 and 3) that is dissimilar to the shape of each inlet 86. Other outlet 84 shapes are also contemplated.

The inlets 86 may be shaped and oriented to direct the cooling airflow CA from the cavity 76 into the cooling holes 78. In one embodiment, the inlet 86 of each cooling hole 78 may be oriented such that it at least partially extends in the same direction as a direction of flow of a cooling airflow CA that is circulated inside the cavity 76. For example, the inlet 86 at position P1 of the body portion 52 includes the angled shape 90 that is oriented to extend in the same direction as the direction of flow of the cooling airflow CA. In this particular embodiment, the cooling airflow CA is communicated in a radially outer direction D1. However, the cooling airflow CA could also be communicated in a radially inner direction D2 (or any other direction) in which case the inlets 86 could be oriented differently to better direct the cooling airflow CA into the cooling holes 78.

Each cooling hole 78 can be formed on the component 50 by utilizing a machining process. In one embodiment, the cooling holes 78 are internally formed in the body portion 52 of the component 50 by machining the cooling holes 78 in a direction that extends from the internal surface 82 toward the exterior surface 80 of the body portion 52. In other words, the cooling holes 78 may be machined from the inside-out of the component 50. By machining the cooling holes 78 from the inside-out, the cooling holes 78 may be formed without a sharp corner or burr at a breakout location at the internal surface 82. In one embodiment, the cooling holes 78 are machined using an electrical discharge machining process (EDM), although other machining processes are also contemplated as within the scope of this disclosure.

Although the different non-limiting embodiments are illustrated as having specific components, the embodiments of this disclosure are not limited to those particular combinations. It is possible to use some of the components or features from any of the non-limiting embodiments in combination with features or components from any other non-limiting embodiments.

It should be understood that like reference numerals identify corresponding or similar elements throughout the several drawings. It should also be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would recognize that various modifications could come within the scope of this disclosure. For these reasons, the following claims should be studied to determine the true scope and content of this disclosure.

What is claimed is:

1. A component for a gas turbine engine, comprising:
a body portion having an exterior surface and an internal surface;
a cavity disposed inside of said body portion; and
a cooling hole that extends between said exterior surface and said internal surface and includes a metering section having an outlet and an inlet, wherein said inlet is shaped dissimilar to said outlet.

2. The component as recited in claim 1, wherein said body portion is an airfoil.

3. The component as recited in claim 1, wherein the component is a vane.

4. The component as recited in claim 1, wherein the component is a blade.

5. The component as recited in claim 1, wherein said inlet includes an angled shape.

6. The component as recited in claim 1, wherein said inlet includes a conical shape.

7. The component as recited in claim 1, wherein said inlet includes a bellmouth shape.

8. The component as recited in claim 1, wherein said metering section is cylindrical.

9. The component as recited in claim 1, wherein said outlet includes a round shape.

10. The component as recited in claim 1, wherein said cooling hole is internally formed in a direction that extends from said internal surface toward said exterior surface.

11. The component as recited in claim 1, comprising a second cooling hole, wherein said inlet of said cooling hole includes a first shape and an inlet of said second cooling hole includes a second shape that is different from said first shape.

12. The component as recited in claim 1, wherein said inlet is oriented to at least partially extend in the same direction as a direction of flow of a cooling airflow that is circulated inside said cavity.

13. The component as recited in claim 1, wherein said inlet includes an upstream portion that is converging.

14. The component as recited in claim 1, wherein said outlet is formed at said exterior surface and said inlet is formed at said internal surface.

15. The component as recited in claim 1, wherein said outlet includes a diffused shape.

16. A gas turbine engine, comprising:
a compressor section;
a combustor section in fluid communication with said compressor section;
a turbine section in fluid communication said combustor section; and
a component disposed in at least one of said compressor section and said turbine section, wherein said component includes:
a body portion having an exterior surface and an internal surface;
a cavity disposed inside said body portion; and
a cooling hole that extends between said exterior surface and said internal surface and includes a metering section having an outlet and an inlet, wherein said inlet is shaped dissimilar to said outlet.

17. The gas turbine engine as recited in claim 16, wherein said inlet includes an angled shape.

18. The gas turbine engine as recited in claim 16, wherein said inlet includes a conical shape.

19. The gas turbine engine as recited in claim 16, wherein said inlet includes a bellmouth shape.

20. The gas turbine engine as recited in claim 16, comprising a second cooling hole, wherein said inlet of said cooling hole includes a first shape and an inlet of said second cooling hole includes a second shape that is different from said first shape.
